(19) United States
(12) Patent Application Publication
(10) Pub. No.: US 2023/0044714 A1
(43) Pub. Date: Feb. 9, 2023

(54) STABILITY OF NON-PETROLEUM OILS USING CANNABINOID COMPOUNDS TO PROVIDE ANTIOXIDATIVE BENEFITS

(71) Applicant: Demetrix, Inc., Berkeley, CA (US)

(72) Inventors: Cynthia W. Bryant, Raleigh, NC (US); Alison Watta, Durham, NC (US)

(21) Appl. No.: 17/877,906

(22) Filed: Jul. 30, 2022

Related U.S. Application Data
(60) Provisional application No. 63/227,726, filed on Jul. 30, 2021.

(51) Int. Cl. A23D 9/06

(52) U.S. Cl. CPC A23D 9/06

(57) ABSTRACT

Methods of improving the stability of a non-petroleum oil using cannabinoid compounds are described herein. The cannabinoid compounds can include cannabigerol (“CBG”) and/or cannabigerolic acid (“CBGA”). The cannabinoid compounds can be antioxidants. Compositions and articles including the cannabinoid compounds are further disclosed.

### CROSS-REFERENCE TO RELATED APPLICATIONS

The present application claims the priority benefit of U.S. Provisional Patent App. Ser. No. 63/227,726, filed Jul. 30, 2021, which is hereby incorporated herein by reference.

### TECHNICAL FIELD

The present disclosure generally relates to the use of cannabinoid compounds and related products to improve the stability of non-petroleum oils and thus increase their respective lifespan.

### BACKGROUND

Non-petroleum oils are oils extracted from plants using either mechanical action or solvents or oils produced from animal sources. In contrast to petroleum-based oils, non-petroleum oils are typically edible and primarily comprise various triglycerides with smaller amounts of other compounds. In addition to their use in cooking and food products, non-petroleum oils have numerous uses including as components and/or bases for personal care products, cosmetic products, skincare products, soaps, paints, varnishes, resins, wood treatment products, fuel, electrical insulators, lubricants, ointments, hydraulic fluids, tire additives, candles, pharmaceutical products, medicines, and perfumes. Known vegetable oils include coconut oil, corn oil, canola oil, cottonseed oil, olive oil, palm oil, peanut oil, rapeseed (sometimes called canola) oil, safflower oil, sesame oil, soybean oil, sunflower oil, nut oils (e.g., almond, beech, brazil, cashew, hazelnut, macadamia, mongo nut, pecan, pine nut, pistachio, walnut, pumpkin seed), citrus oils (e.g., grapefruit seed, lemon, and orange), melon and gourd seed oils, acai oil, black seed oil, blackcurrant seed oil, borage seed oil, evening primrose oil, rose hip oil, argan oil, and flaxseed oil among numerous other oils. Oils of animal origin include animal and fish oils as well as certain fats from animals.

### DETAILED DESCRIPTION

Despite their numerous useful applications, non-petroleum oils have several drawbacks. Most critically, non-petroleum oils can suffer from short lifespans due to stability issues caused by oxidative damage from exposure to light, heat, and oxygen. Known techniques to mitigate such oxidative damage include refining the oils through one or more of purification, filtering, distilling, degumming, neutralization, bleaching, dewaxing, deodorizing, and the addition of preservatives. However, even refined non-petroleum oils are still subject to short lifespans caused by oxidative damage.

Selection of the non-petroleum oil can also influence the stability and intended uses with certain non-petroleum oils exhibiting greater resistance to oxidative damage. For example, vegetable oils formed of saturated triglycerides can be more resistant to oxidative damage than vegetable oils formed with only unsaturated triglycerides. Vegetable oils formed from polyunsaturated fats and oils are the most susceptible to oxidative damage.

Additionally, certain non-petroleum oils are processed before use to modify their properties, performance, and appearance. Such processing treatments can increase the risk of oxidative damage. For example, sesame oil and toasted nut oils are subjected to heat when they are produced and this treatment can increase the risk of further oxidative damage. Examples of non-petroleum oils which are prone to oxidative damage include sesame oil, toasted walnut oil, rose hip oil, argan oil, almond oil, and sunflower oil.

It has presently been discovered that the oxidative stability of non-petroleum oils can be improved through the inclusion of one or more cannabinoid compounds. The one or more cannabinoid compounds can act as antioxidants and can improve the lifespan and/or performance of both non-petroleum oils and compositions and articles including the non-petroleum oils. Generally, the cannabinoid compounds described herein can be included in any non-petroleum oil used for any purpose.

A non-limiting list of suitable vegetable oils includes coconut oil, corn oil, canola oil, cottonseed oil, olive oil, palm oil, peanut oil, rapeseed (sometimes called canola) oil, safflower oil, sesame oil, soybean oil, sunflower oil, nut oils (e.g., almond, beech, brazil, cashew, hazelnut, macadamia, mongo nut, pecan, pine nut, pistachio, walnut, pumpkin seed), citrus oils (e.g., grapefruit seed, lemon, and orange), melon and gourd seed oils, acai oil, black seed oil, blackcurrant seed oil, borage seed oil, evening primrose oil, rose hip oil, argan oil, and flaxseed oil. Suitable animal based oils include pig fats, chicken fats, bovine fats, cod liver oil, whale oil, shark liver oil, certain milk-derived products including butter, goose fat, lard, schmaltz, tallow, ghee, suet, and other shortenings.

As can be appreciated, antioxidants refer to compounds which can stop, or reduce, various oxidative reactions, such as free radical chain reactions, from propagating and causing further damage. The cannabinoid compounds described herein can act as antioxidants against one or more of peroxyl radicals, hydroxyl radicals, peroxynitrite radicals, superoxide anions, singlet oxygen, and hypochlorite. It has presently been discovered that certain cannabinoid compounds can act as highly effective antioxidants that are more effective than known antioxidants such as rosemary extract and Vitamin E. For example, the cannabinoid compounds can be 150% more effective than Vitamin E in certain embodiments.

It has been surprisingly found that the antioxidant properties of cannabinoid compounds are not predictable despite sharing similar chemical structures. For example, it has been discovered that cannabigerol (“CBG”) and cannabigerolic acid (“CBGA”) exhibit excellent antioxidant properties while cannabidiol (“CBD”) exhibits poor antioxidant properties. CBG and GBGA are hydroxy benzoic acids and can each act as an antioxidant by reaction of a radical with the benzoic ring and the release of a carboxylic acid which can further stop propagation of a second radical.

Prior to the present discovery, it was not appreciated which specific cannabinoid compounds exhibited antioxidant properties as isolated cannabinoid compounds were not widely available. By selecting only cannabinoid compounds which exhibit antioxidant properties, the methods, compositions and products described herein can improve the shelf life and performance of non-petroleum oils through addition of only small amounts of specific cannabinoid compounds.

The present discovery was facilitated by the Applicant's unique methods of producing hereto rare cannabinoid compounds in appreciable quantities including through chemical synthesis reactions and growth in yeast cultures. Prior to the Applicant's research, the lack of viable production of individual cannabinoid compounds obviated the ability to produce only specific antioxidants for non-petroleum oils. Additional details about the production of producing rare cannabinoid compounds are described in PCT Patent Application Nos. WO 2020/069142 A1, WO 2020/069214 A2, WO 2021/05597 A1; and WO 2020/236789 A1, each of which is incorporated herein by reference.

Prior to the Applicant's process of isolating specific and unique cannabinoid compounds from non-horticultural sources, cannabinoid compounds were extracted and isolated only from naturally grown marijuana plants which drastically limited the volume of the rarer cannabinoid compounds available for research or use. Thus, these non-horticulturally-derived cannabinoid compounds offer antioxidant benefits not previously contemplated. As used herein, non-horticulturally derived cannabinoid compounds refers to cannabinoid compounds not grown in plants (e.g., not through horticulture or agriculture).

Additionally, isolated cannabinoid compounds extracted from marijuana plants can also suffer from purity issues as certain unavoidable containments (such as other natural marijuana plant compounds, irremovable amounts of other cannabinoid compounds, etc.) can remain present in isolated cannabinoid compounds extracted from marijuana plants. Such unavoidable containments can impact the quality of the data or even alter the apparent functioning of the cannabinoid compounds. Compositions and methods of stabilizing non-petroleum oils that use horticulturally derived cannabinoid compounds may not exhibit the same effects as compositions and methods using purer cannabinoid compounds such as the cannabinoid compounds contemplated herein. For example, a blend of cannabinoid compounds from a natural marijuana plant may increase the risk of one of the cannabinoids acting as a pro-oxidative agent and increasing oxidative damage.

As can be appreciated however, horticulturally derived cannabinoid compounds can be used in certain embodiments of the disclosure if the horticulturally extracted cannabinoid compounds are sufficiently pure and/or if any containments are sufficiently well understood.

Generally, the stability, and thus lifespan, of a non-petroleum oil or product including such a non-petroleum oil can be improved by inclusion of CBG or CBGA. In certain embodiments, each of CBG and CBGA can be included in a composition or article to improve stability while in other embodiments, only one of CBG and CBGA can be included in such compositions and articles.

The amount of CBG and/or CBGA included in a non-petroleum oil can vary depending on the application, amount, and identity of the vegetable oil. For example, relatively more cannabinoid compounds may be necessary to stabilize highly unsaturated non-petroleum oils compared to a more stable vegetable oil that is highly saturated and is solid at room temperature. Similarly, relatively more cannabinoid compounds may be necessary if the composition or product is subject to conditions which would normally induce oxidative damage and breakdown such as non-petroleum oils or articles thereof which are exposed to heat or light during production, processing, transportation, storage, or use.

In certain embodiments, the cannabinoid compounds can be included at about 1,000 parts-per-million (“ppm”) of the non-petroleum oil or less. For example, in certain embodiments, the cannabinoid compounds can be included at about 750 ppm of the non-petroleum oil or less; about 500 ppm of the non-petroleum oil or less; about 300 ppm of the non-petroleum oil or less; about 150 ppm of the non-petroleum oil or less, or about 100 ppm of the non-petroleum oil or less.

As can be appreciated, certain antioxidant compounds can exhibit pro-oxidative damage at high concentrations. In certain embodiments, the antioxidant benefits of the cannabinoid compounds can be extended by the addition of additional cannabinoid compounds as the antioxidant benefits are exhausted. In certain embodiments, the additional cannabinoid compounds can be added through manual addition while in other embodiments, the cannabinoid compounds can be held in an inactive configuration that disperses the cannabinoid compounds over a controlled period of time (e.g., through slow-release encapsulation).

As can be appreciated, the relative concentration of the cannabinoid compounds can vary in different compositions and products. For example, a walnut oil may need more of the cannabinoid compounds described herein than a more stable oil. Likewise, an article or product using a non-petroleum oil as a base may need less of the cannabinoid compounds if the article or product also helps to stabilize the non-petroleum oil. In certain embodiments however, the total amount of the cannabinoid compounds can be the same between such two compositions and articles. In other embodiments, both the concentration and amount of cannabinoid compounds can vary between different compositions and articles.

In certain embodiments, the relative amounts of each of CBG and CBGA can vary in the compositions and articles described herein. For example, each individual cannabinoid compound can vary from the cannabinoid compound by about 1,000:1 to about 1:1,000.

In certain embodiments, the compositions, articles, and methods described herein can be substantially or entirely free of cannabinoid compounds other than CBG and CBGA. For example, the compositions, articles, and methods can be substantially or entirely free of CBD and tetrahydrocannabinol (“THC”). As used herein, substantially free can mean less than about 5%, less than about 4%, less than about 3%, less than about 2%, less than about 1%, less than about 0.5%, less than about 0.1%, or less than about 0.01%. In certain embodiments, the cannabinoid compounds can be produced using non-horticulturally-derived methods such as through chemical synthesis (e.g., organic synthesis reactions) or through modification of yeast and/or bacterial cells to produce the cannabinoid compounds in high purity. However, in certain embodiments, cannabinoid compounds can also be a natural product, e.g., an extract of a cannabis plant if sufficiently pure. In certain embodiments, substantially pure means that the isolated cannabinoid compound, when added, includes about 3% or less of contaminants, about 2% or less of contaminants, about 1% or less of contaminants, about 0.5% or less of contaminants, about 0.1% or less of contaminants, or about 0.01% or less of contaminants.

In certain embodiments, the cannabinoid compounds can be added prior to use of the non-petroleum oil or article containing the non-petroleum oil. In alternative embodiments, the cannabinoid compounds can additionally, or alternatively, be periodically added to the non-petroleum oil or products.

In certain embodiments, the cannabinoid compounds can be added before, or after, damage to the non-petroleum oil has occurred. As can be appreciated, the cannabinoid compounds can prevent further damage to the non-petroleum oils from occurring and, in certain embodiments, restore at least some performance to a non-petroleum oil that has been previously damaged.

As will be appreciated, a wide variety of different compositions and articles can be prepared which include the one or more cannabinoid compounds of the present disclosure including compositions and articles not listed here. Any composition or article including a non-petroleum oil can be improved through addition of the cannabinoid compounds described herein. Such compositions and articles include personal care products, cosmetic products, skincare products, soaps, paints, varnishes, resins, wood treatment products, fuel, electrical insulators, lubricants, ointments, hydraulic fluids, tire additives, candles, pharmaceutical products, medicines, and perfumes. All such compositions and articles are contemplated herein as they are within the ordinary skill of artisans based on the guidance provided in the present disclosure.

Generally, all of the compositions and articles described herein can be manufactured and produced as known in the art. For example, in certain embodiments, the cannabinoid compounds can be dissolved in a suitable solvent such as an alcohol or oil and then added to the composition or article. In certain embodiments, the cannabinoid compounds described herein can be dissolved directly in the non-petroleum oil of interest.

### Examples

The potential of cannabinoid compounds to improve the stability and shelf life of non-petroleum oils was demonstrated by evaluating the antioxidant properties of CBD, CBG, and CBGA using three assays: the Trolox Equivalent Antioxidant Capacity (“TEAC”) assay, the Oxygen Radical Absorbance Capacity (“ORAC”) assay, and the 2,2-diphenyl-1-picrylhydrazyl (“DPPH”) assay. Each assay reports the mole of trolox equivalents (“TE”) per gram of the evaluated compound. Trolox (6-hydroxy-2,5,7,8-tetrametyhlchroman-2-carboxylic acid) is a water-soluble analog of vitamin E. TEAC measures the ability of antioxidants to scavenge the stable radical cation of ABTS (2,2′-azino-bis(3-ethylbenzothiazoline-6-sulfonic acid), a blue-green chromophore with maximum absorption at 734 nm that decreases in its intensity in the presence of antioxidants. The ORAC assay measures scavenging activity against oxygen radicals that are known to be involved in the pathogenesis of aging and common diseases. Naguib et al. J Nutr Sci Vitaminol 49(4):217-20 (2003). DPPH measures the reduction of the DPPH radical in the presence of an antioxidant molecule. TEAC, ORAC, and DPPH assays are standardized measures of antioxidant performance. Table 1 depicts the antioxidant properties of CBD, CBG, and CBGA.

TABLE 1

| | CBD | CBG | CBGA |
|---|---|---|---|
| | (μmole | (μmole | (μmole |
| Analysis | TE/gram) | TE/gram) | TE/gram) |
| TEAC | 164.63 | 1,643.81 | 5,180 |
| ORAC against peroxyl | 146.27 | 4,666.00 | 6,888 |
| radicals | | | |
| ORAC against hydroxyl | 331.36 | 37.44 | 13,080 |
| radicals | | | |
| ORAC against peroxynitrite | 0.23 | 0.26 | 166 |
| ORAC against super oxide | Not | Not | 3,302 |
| anion | Detected | Detected | |
| ORAC against singlet oxygen | 93.80 | 86.09 | 1,355 |
| ORAC against hypochlorite | 161.18 | 88.43 | 9,251 |
| DPPH | 164.47 | Not | 631 |
| | | Detected | |

TEAC results of 1,643 mole TE/gram and 5,180 mole TE/gram for CBG and CBGA respectively demonstrate a higher antioxidant capacity than rosemary extract, a known antioxidant compound. Rosemary extract has a TEAC antioxidant capacity of 1241 mole TE/gram.

The CBG ORAC measurement of 4,666 mole TE/gram against peroxyl radicals and the CBGA ORAC measurement of 6,888 mole TE/gram are also greater than other known natural antioxidants, such as d-alpha-tocopherol, mixed tocopherols, and tocotrienols. For example, the ORAC measurements against peroxyl radicals is 1,293 mole TE/gram for d-alpha-tocopherol; 1,948 mole TE/gram for mixed tocopherols; and 1,299 mole TE/gram for tocotrienols.

As can be appreciated, the most common non-petroleum oils exhibit relatively weak antioxidant properties. For example, Table 2 lists the ORAC (against free radicals) and the TEAC values for some common non-petroleum oils.

TABLE 2

| | ORAC (μmole | TEAC (μmole |
|---|---|---|
| Non-Petroleum Oil | TE/gram) | TE/gram) |
| Canola Oil | 460 | — |
| Extra Virgin Olive Oil | 372 | — |
| Corn Oil | 340 | — |
| Peanut Oil | 106 | — |
| Coconut Oil | 1070 | 2.76 |
| Sunflower Oil | — | 4.08 |
| Sesame Oil | — | 3.92 |

As depicted in Table 2, it is evident that common non-petroleum oils have relatively weak antioxidant properties and accordingly exhibit weak stability. Although it is known to include antioxidants such as mixed tocopherols in non-petroleum oils to improve their stability, the cannabinoids described herein exhibit substantially stronger antioxidant effects and should improve the stability of the non-petroleum oils to a greater extent than known antioxidants.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

It should be understood that certain aspects, features, structures, or characteristics of the various embodiments can be interchanged in whole or in part. Reference to certain embodiments mean that a particular aspect, feature, structure, or characteristic described in connection with certain embodiments can be included in at least one embodiment and may be interchanged with certain other embodiments. The appearances of the phrase “in certain embodiments” in various places in specification are not necessarily all referring to the same embodiment, nor are certain embodiments necessarily mutually exclusive of other certain embodiments. It should also be understood that the steps of the methods set forth herein are not necessarily required to be performed in the orders described, and the order of the steps of such methods should be understood to be merely exemplary. Likewise, additional steps can be included in such methods, and certain steps may be omitted or combined, in methods consistent with certain embodiments.

What is claimed is:

1. A composition comprising a non-petroleum oil and one or more cannabinoid compounds selected from the group consisting of cannabigerol (“CBG”), cannabigerolic acid (“CBGA”), and combinations thereof, wherein the composition exhibits greater stability than an identical non-petroleum oil without the one or more cannabinoid compounds.

2. The composition of claim 1 comprises about 500 parts-per-million (“ppm”) or less of the one or more cannabinoid compounds.

3. The composition of claim 1 comprises about 180 ppm to about 250 ppm of the one or more cannabinoid compounds.

4. The composition of claim 1 is a liquid.

5. The composition of claim 1, wherein the one or more cannabinoid compounds are non-horticulturally derived cannabinoid compounds.

6. The composition of claim 1 has a longer lifespan than a similar non-petroleum oil without the one or more cannabinoids.

7. A method of stabilizing a non-petroleum oil, the method comprising the addition of one or more cannabinoid compounds selected from the group consisting cannabigerol (“CBG”), cannabigerolic acid (“CBGA”), and combinations thereof.

8. The method of claim 7, wherein the one or more cannabinoid compounds are added at about 500 parts-per-million (“ppm”) or less.

9. The method of claim 7, wherein the one or more cannabinoid compounds are non-horticulturally derived cannabinoid compounds.
